(19) United States
(12) Patent Application Publication
(10) Pub. No.: US 2023/0415971 A1
(43) Pub. Date: Dec. 28, 2023

(54) INTEGRATED INLINE ONE-WAY VALVE

(71) Applicant: Gorby LLC, Saint Paul, MN (US)

(72) Inventors: George Gorbatenko, St. Paul, MN (US); Robert Pierce Travis, Plymouth, WI (US)

(21) Appl. No.: 18/214,792

(22) Filed: Jun. 27, 2023

Related U.S. Application Data
(60) Provisional application No. 63/356,187, filed on Jun. 28, 2022.

(51) Int. Cl. B65D 77/22; B65D 33/01; B65D 65/46; F16K 24/04; B65D 85/804

(52) U.S. Cl. CPC B65D 77/225; B65D 33/01; B65D 65/466; F16K 24/04; B65D 85/8043; B65D 2205/02

(57) ABSTRACT

The disclosure provides a one-way valve for coffee packaging that can be implemented on a manufacturing line. The disclosed valve has a vent pressure can be adjusted to capture maximum coffee flavor without bursting the packaging. The valve is applicable to flex coffee packs as well as single serve coffee pods.

### PRIORITY CLAIM

This application claims the benefit of U.S. Provisional Patent Application No. 63/356,187, filed Jun. 28, 2022, wherein the contents of this application is incorporated herein by reference in its entirety.

### BACKGROUND

Coffee is a popular beverage enjoyed worldwide. It is well known among discriminating users that it is best consumed when packaged fresh.

In 1881 Max J. Brandenstein, an early pioneer in the coffee, packaged coffee in sealed metal tins. On first opening the swish of escaping gas along with the intense aroma of fresh coffee was the hallmark of MJB coffee.

In 1966 Alfred Peet, experimenting with varietal beans and roasting techniques introduced the artisan approach to coffee and is credited with starting the next wave of coffee production. Flexible packaging of coffee seemed will suited to small batch roasting. Soon after, Starbucks opened its doors and is credited with solving the “bursting bag” problem by the use a 1-way valve.

Today, virtually every soft pack of coffee contains a one-way valve

### Anatomy of a 1-Way Valve

One-way valves can be grouped in two broad categories: rigid and flexible.

Rigid valves typically consist of 3 parts: a rigid top that vents to the atmosphere, a bottom that interfaces the outgassing element, and a resilient disk held captive. The disk responds to differential pressure and either opens or closes the valve. Googlio, U.S. Pat. No. 3,595,467, is among the earliest examples. Many follow and differ in the travel path the escaping gas takes. Judging from examining countless bags, this group is preferred in the coffee industry.

Flexible valves are made from several pieces of film that mimic the operation of the rigid valves and seem to be directed to specialty cases. Metzger U.S. Pat. Nos. 2,821,722; 2,927,722 and 2,946,502, call for oil films in the middle area (which would preclude food applications). Typically, two parts are appended to the surface of the container holding the out-gassing material which constitutes the third surface. Because the scale of the figure is so small, it is difficult to make an accurate assessment of the valve derail.

A two-film valve is shown in U.S. Pat. No. 11,142,384 B2, Buckingham (principally FIGS. 4, 5 and 6) as the base valve however there is no detail to indicate how such a valve can be built. Instead, the inventor leaves that important detail to someone “skilled in the art” to make and use. Since the other valves shown build on this base valve, one is unable to reach a conclusion except for it would likely be expensive to fabricate.

### STATE OF THE ART

To summarize the art, the valves are expensive, generally disruptive to the manufacturing process, and lack flexibility.

Cost. The cost of ready to insert a valve varies from $0.25 to perhaps $0.75. Pre-valved bags are priced at $1.00. In an industry that fights for every penny, the valve is major cost consideration.

Disruptive. The ideal manufacturing process is to start at one end and have finished product at the other end. Currently, after printing the process is stopped and then fed to machine that inserts the valves and then finally to a station that will fold and form the bag. This is complicated and costly.

Inflexible. Valves start to open at 2-3 mbar (0.05 psi) for fear of bag rupture. It is not unusual for the pressure of un-restrained coffee package to reach 13 psi due to out-gassing. Hence the valves are venting virtually all the very flavor that is being sought after. Because each roast-bean combination is apt to offer a different out-gas profile. It would be desirable to adjust vent pressures to achieve optimum results short of rupture.

### OBJECTIVE OF INVENTION

The objective of the invention is to define a one-way valve.
that can be built for a cost that is comparable to the material cost of a package without valve.
that can be implemented on a manufacturing line without disturbance.
where the vent pressure can be adjusted to capture maximum flavor without bursting package.
that is applicable to flex packs as well as single serve pods.

### Film Considerations

As described earlier, the valve is composed of a primary film to which a secondary “valve film” is bonded. Depending on the application, generally, the films for flex-packs has to be able to be bonded to itself. In a compostable case, a commercially available obtained from INNOVIA, a lamination of several films, can be used.

When valve is used in a compostable lidding application, a compatible film, such as BI-AX, is first laminated to the INNOVIA film so as to insure a good lid-to-pod seal. The secondary film would be of like construction.

Depending on the application, the primary and secondary valve films can be built using commercially available components for either compostable or non-compostable cases. In either case, however, it is important that the primary film remain flexible.

### DESCRIPTION OF FIGURES

FIG. 1 Plan view of packaging film (1) as seen on the print surface. The attached valve film (4) is shown in dotted lines. Fold lines (6) indicated in phantom lines. The shaded area (10) forms a pocket when the line segment αβ is bonded to line segment γδ in the course of forming the package along the fold lines (6).

FIG. 2 Blow-up view of valve showing the exit port (8) on the packaging film (1) and the entry port (9) on the valve film (4). The ports are shown separated by distance L (5). The valve film (4) is attached to the packaging film (1) by thermal bond (7).

FIG. 3 The valve is shown in the closed position and the differential pressure is zero; Pa=Pc.

FIG. 3 The out-gas pressure Pc1 (shown shaded) causes the two layers to begin separation. The valve remains closed; Pc1>Pa.

FIG. 3C The out-gas pressure Pc2 has increased to point where the valve to open allowing the out-gas to leave through the exit port; Pc2>>Pa.

FIG. 4 Shows a plan view of the packaging film as would be used for single serve pods. The valve film (1′) is fastened to the valve film (7′) as is indicated in the edge view of the two films. The functional components are analogous to those shown for the flexible bag. Save for adding a prime notation (′) to differentiate the difference.

FIG. 5 Shown is the cross section of a filled pod that has been filled, sealed and trimmed around the periphery (7″). The out-gas process has started but the valve is yet closed.

FIG. 6 By joining line seg αβ may and line seg γδ a three-dimensional valve is achieved containing an entry port (9) and an exit port (8) where out-gas travels from entry to exit ports.

FIG. 7 Shows a graph of the results of testing the described one-way valve.

### EMBODIMENT I COFFEE FLEX-PACK

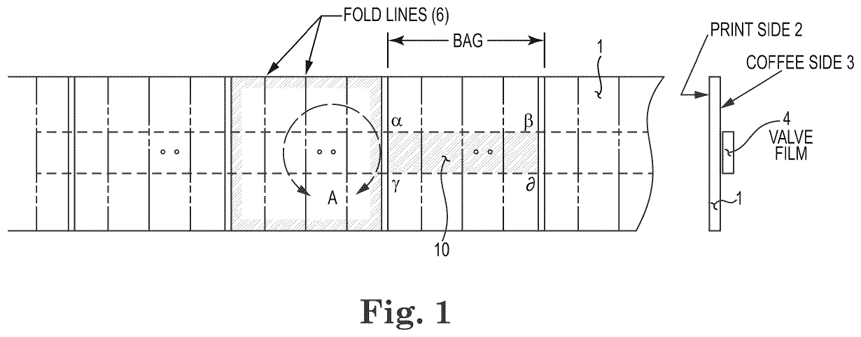

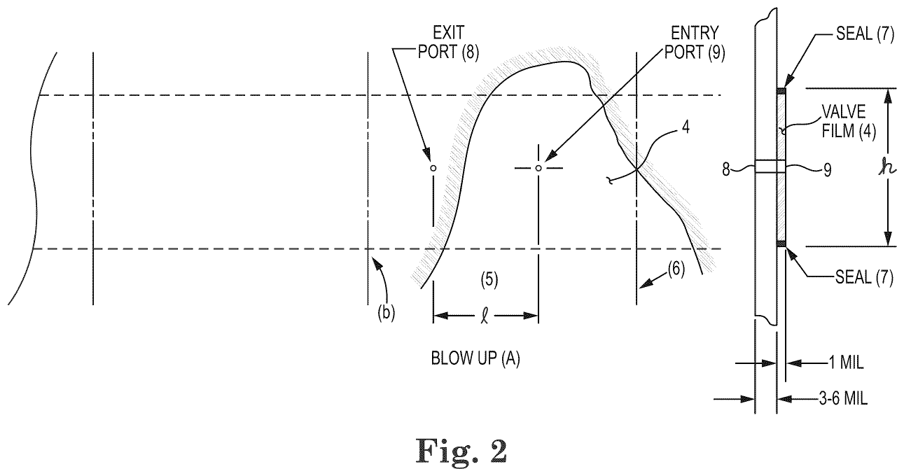

Consider the configuration shown in FIG. 1. which depicts a production run for a flex packet using flexible film (1) To the original flexible packing film (1) is bonded to a second strip of film (4) at the underside (3). This strip can be approximately 2″ wide and bonded for the entire length of the packaging film roll at the top and bottom points of the strip (7). A hole in the top film will later be shown to serve as an exit port (8). Similarly, a hole is placed in the added (valve) strip will serve as an entry port (9). The distance between the holes is shown as L and can be nominally 1 inch.

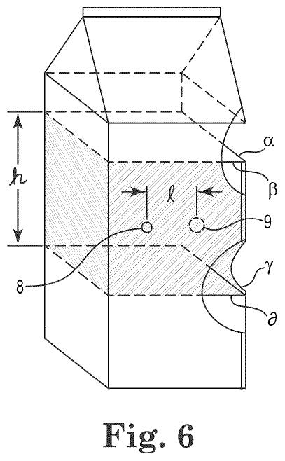

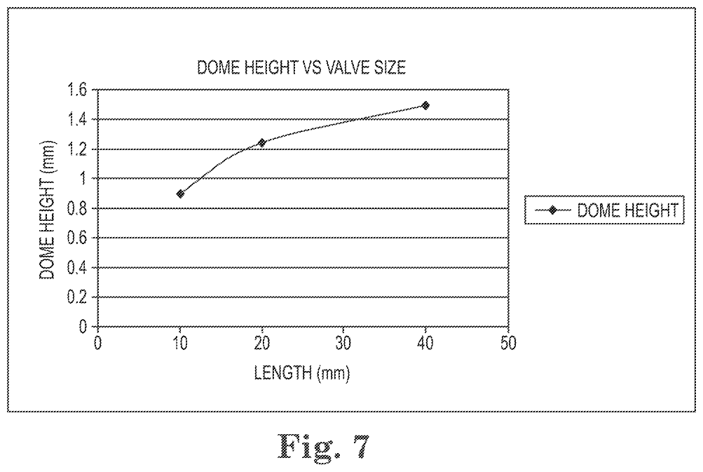

At this point, the configuration is a sandwich of two films, each of which has a hole that is offset from each other by L inches. It is when the film is cut along bag line and folded so that the line segment αβ is bonded to line segment γδ that the valve assumes it's final form as shown in FIG. 6.

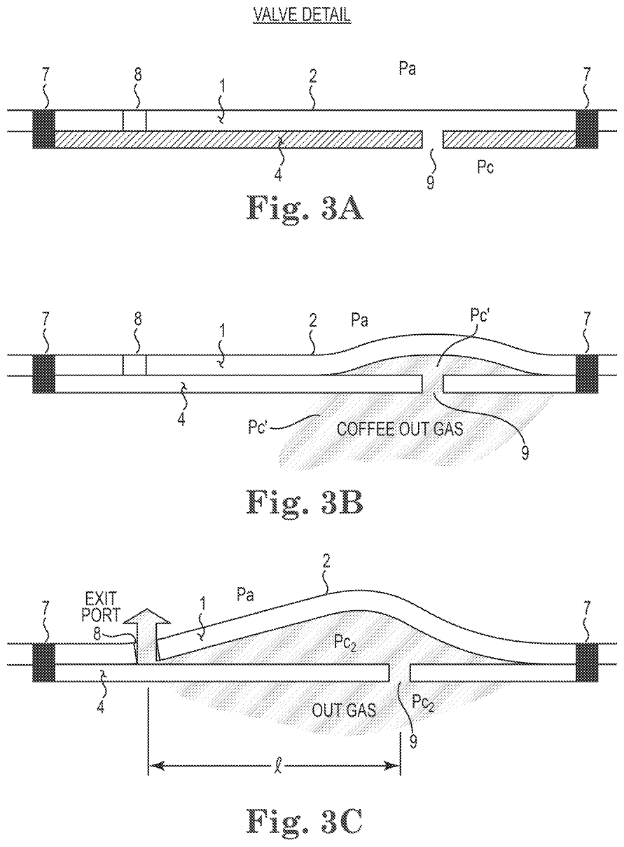

The operation of a valve so constructed can be best described using FIG. 3. In FIG. 3A, the valve is shown closed. The ambient pressure Pa is equal to the coffee pressure, Pc. Thus Pa=Pc. Increasing Pa further blocks the path between ports, thereby deterring the entry of Oxygen. This makes the valve one-way.

In FIG. 3B, the coffee begins to out-gas as is indicated by shading the area around the entry port (9). Pc′>Pa. Because the pressure is relatively low, the valve remains closed.

In FIG. 3C, the out-gas pressure Pc″ is so large that the valve opens up. This then is the control (set) point of the valve. Increasing the distance between the holes will raise the set-point of the valve. Conversely, reducing the distance lowers the set-point

The hole size dictates the responsiveness of the valve. Since the out-gas is generally a slow-moving process, the best results were achieved with the smallest hole that is practical. The exception might be when packed coffee is shipped by air in the untreated cargo space of the aircraft.

This embodiment is well suited to flexible packs where the main emphasis is to keep the bag from bursting and keep the Oxygen out. The valves are typically set to open at 2-3 mB (0.05 psi). where the distance between holes would be less.

### EMBODIMENT II SINGLE SERVE PODS

Background. As with coffee packed in flex packs, ground coffee packed in single-serve pods are best when packed fresh. This offers advantages but introduces challenges.

Pods freshly packed will dome the lid due to the out-gas pressure, estimated to be 10-15 psi. This pressure greats a chemical equilibrium, effectively stopping the “aging clock”. Furthermore, the higher pressure in the pod defeats the entrance of Oxygen from the ambient air. The net is a very fresh cup of coffee.

The problem with pods is that excessively active coffee could exceed the shear limits of the lid film and cause the lid to rupture (as well as more subtle problems). Secondly, shipping pods under pressure by air in untreated cargo holds, could likely (and do) burst the lids.

The practical solution is to wait about 12 hours after grinding there by letting the out-gas process to subside somewhat. However, since each bean-roast combination has a different profile; this process is empirical. Reduce the wait time and the pod's lid might burst. Increase the time and flavor might be needlessly lost. As to transport, one is limited to ground transport; off-shore destinations remain problematic.

Solution. By installing a 1-way valve in each pod, both problems are addressed. Because the typical standard lid diameter for a single serve pod is 2.1 inches we are limited as to the distance of the hole pair, likely 1.5 in, and choose an exit port (hole) that yields a valve set point of approximately 10 psi. This will produce a nice dome while insuring against a lid bursting.

Description. Consider the configuration shown in FIG. 4. We retain the same designation for the component parts but add a prime (′) to differentiate between the elements of the flex-package and the pod.

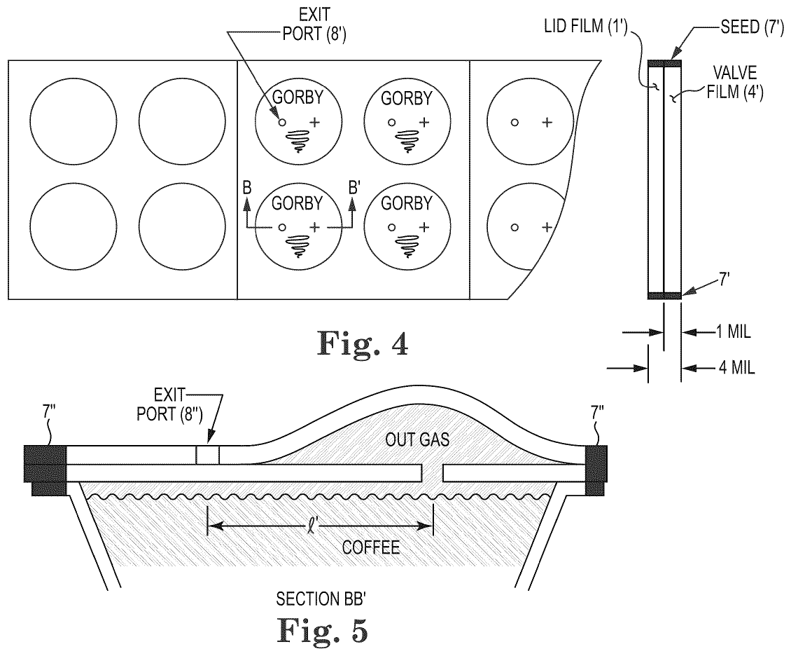

Note that the valve film (9′) matches the width of the lid film. Including an index band (not shown), the film is 6.5 in wide. In the course of sealing and trimming the pod lid, the valve is sealed all the way around (7′) creating a pouch that encloses the valve save fort the exit port. As seen in FIG. 5, the operation of the valve follows that as earlier described for the flex-pack

### EXPERIMENTAL RESULTS

In order to characterize the operation of the valve, it is important to study how the valves operate in response to pressure be it caused by a vacuum chamber or out-gassing from fresh roast.

A test vehicle was built using a pod along the lines suggested in FIG. 5. Three configurations were constructed: a valve separation of 10, 20 and 40 mm (the most restrictive). In addition, a “non-valve” valve was constructed to serve as a reference.

When the samples were subjected to a vacuum of 0.92 atm, the results are shown in FIG. 7. Here we see, the most restrictive valve has a dome height of 1.5 mm. Given the reference pod domed at 2.6 mm for the same environment, the valve is operating at about 7.8 psi. When returned to normal atmosphere, the valves exhibited a concave shape that was expected of a one-way valve.

Testing with coffee and different film, produced comparable results. It should also be noted that over the course of testing many hundreds of valves, there were no failures in the high vacuum test.

### SUMMARY

The value and importance of packaging coffee fresh from the roast is as key today as it was over 100 years ago when Max J. Brandestein packed his coffee in metal tins. The described invention attempts to duplicate that freshness end result. The simplicity of the design is not lost and serves to affirm correctness. The best designs are often the simple designs. If the packaging film is compostable, so is the valve.

1. A one-way valve to control pressure in a container filled with an outgassing material comprising a resilient polymer portion associate with the container having a venting aperture providing an opening from an interior of the container to an exterior of the container, and a layer of material having an upper and a lower surface, and one or more entry ports completing a path to the venting aperture, having a portion of the upper surface attached to an interior surface of the resilient polymer portion and overlaying the venting aperture of the resilient polymer portion, wherein the layer of material is i) in an operable closed position restricting outgassing when pressure within the container is less than a first predetermined limit and ii) in an operable open configuration allowing outgassing when pressure within the container exceeds a second predetermined limit that separates a portion of the layer of the material from the resilient polymer portion of the container.

2. The valve of claim 1, wherein the container is a sealed bag.

3. The valve of claim 1, wherein the layer of material is adhered to an interior surface of the sealed bag.

4. The valve of claim 1, wherein the container is single serve beverage capsule.

5. The valve of claim 1, wherein the layer of material is adhered to a lid of the single serve beverage capsule.

6. The valve of claim 1, wherein the container is not compostable.

7. The valve of claim 1, wherein the valve and container are compostable.

8. The valve of claim 1, wherein the valve is integrally formed with the container.

9. The valve of claim 1, wherein the valve comprises a resilient material.

10. The valve of claim 1, wherein the venting aperture is one or more punctures in the container.

11. The valve of claim 1, wherein the container is a laminate film.

12. The valve of claim 1, wherein the valve is formed during inline manufacturing processes.

13. The valve of claim 1 wherein the layer of material of the valve is a heat seal film.

14. The valve of claim 1, wherein the valve returns to the operable closed position after outgassing lowers pressure in the container.

15. The valve of claim 1, wherein the venting aperture comprises one or more punctures configured to be offset from the venting aperture.

16. A flexible sealed bag comprising a one-way valve to control pressure in the sealed bag filled with an outgassing material, the valve comprising a layer of material having an upper and a lower surface, and one or more entry ports completing a path to the venting aperture, having a portion of the upper surface attached to an interior surface of the sealed bag and overlaying a venting aperture, the layer of material is i) in an operable closed position restricting outgassing when pressure within the container is less than a first predetermined limit and ii) in an operable open configuration allowing outgassing when pressure within the container exceeds a second predetermined limit that separates a portion of the layer of material from the interior surface of the sealed bag.

17. The sealed bag of claim 16, wherein the valve is adhered to an interior of an exposed outer surface of a flexible sealed bag.

18. A single serve beverage capsule comprising a one-way valve to control pressure in the beverage capsule filled with an outgassing material, the valve comprising a layer of material having an upper and a lower surface, and one or more entry ports completing a path to the venting aperture, having a portion of the upper surface attached to an interior surface of the beverage capsule lid and overlaying a venting aperture, the layer of flexible material is i) in an operable closed position restricting outgassing when pressure within the container is less than a first predetermined limit and ii) in an operable open configuration allowing outgassing when pressure within the beverage capsule exceeds a second predetermined limit that separates a portion of the layer of material from the interior surface of the beverage capsule lid.

19. The beverage capsule of claim 18, wherein the valve is adhered to an interior of a of the beverage capsule lid exposed to an outer surface of the beverage capsule during inline manufacturing processes
